(19) United States
(12) Patent Application Publication
(10) Pub. No.: US 2022/0308556 A1
(43) Pub. Date: Sep. 29, 2022

(54) DELIVERY ROBOT AND NOTIFICATION METHOD

(71) Applicant: HONDA MOTOR CO., LTD., Tokyo (JP)

(72) Inventors: Nozomi Noda, Tokyo (JP); Kuniaki Matsushima, Tokyo (JP); Isao Uematsu, Tokyo (JP); Yurie Kondo, Tokyo (JP); Kensaku Yamamoto, Tokyo (JP)

(73) Assignee: HONDA MOTOR CO., LTD., Tokyo (JP)

(21) Appl. No.: 17/703,333

(22) Filed: Mar. 24, 2022

(30) Foreign Application Priority Data
Mar. 29, 2021 (JP) 2021-055776

(51) Int. Cl. G05B 19/4155; G05D 1/02; B60Q 5/00; B60Q 1/50; B60R 21/0134; G06Q 10/08

(52) U.S. Cl. CPC G05B 19/4155; G05D 1/0246; B60Q 5/005; B60Q 1/50; B60R 21/0134; G06Q 10/083; G05D 2201/0211; B60R 2021/0065

(57) ABSTRACT

A delivery robot that delivers a delivery item in a building comprises: a first acquisition unit configured to acquire external environment information; a travel control unit configured to control traveling of the delivery robot to a delivery destination in the building on the basis of the environment information acquired by the first acquisition unit; and a notification unit configured to perform notification in a case where an opening operation of a door existing in a traveling direction of the delivery robot is detected during the traveling of the delivery robot on the basis of the environment information acquired by the first acquisition unit. The notification unit performs notification by at least one of light and sound toward the door.

### CROSS-REFERENCE TO RELATED APPLICATION(S)

This application claims priority to and the benefit of Japanese Patent Application No. 2021-055776 filed on Mar. 29, 2021, the entire disclosure of which is incorporated herein by reference.

### BACKGROUND OF THE INVENTION

### Field of the Invention

The present invention relates to a delivery robot of delivering a delivery item and a notification method.

### Description of the Related Art

In recent years, an autonomously movable robot has been known. International Publication No. 2020/049978 describes a moving device that determines whether or not an object approaching the moving device is a person. Japanese Patent Laid-Open No. 2011-248713 describes an evacuation place search system that searches for an evacuation place where an autonomous mobile body is to evacuate in order to avoid contact with an approaching obstacle.

International Publication No. 2018/066052 describes an autonomous mobile body that detects a shape of a detection target on the basis of a distance to an object present around a casing and determines whether or not the detection target is a landing door of an elevator on the basis of the detected shape. Japanese Patent Laid-Open No. 2017-220123 describes a device that in a case where there is an obstacle in a car of an elevator, controls a robot main body to move to and stop at a reachable stop position candidate that secures a safe distance from the obstacle.

International Publication No. 2018/066054 describes an elevator control device capable of calling attention to contact between a user and an autonomous mobile body in an elevator shared by the user and the autonomous mobile body.

### SUMMARY OF THE INVENTION

The present invention provides a delivery robot and a notification method that reduce a possibility of collision caused by an opening operation of a door.

The present invention in its first aspect provides a delivery robot that delivers a delivery item in a building, the delivery robot comprising: a first acquisition unit configured to acquire external environment information; a travel control unit configured to control traveling of the delivery robot to a delivery destination in the building on the basis of the environment information acquired by the first acquisition unit; and a notification unit configured to perform notification in a case where an opening operation of a door existing in a traveling direction of the delivery robot is detected during the traveling of the delivery robot on the basis of the environment information acquired by the first acquisition unit, wherein the notification unit performs notification by at least one of light and sound toward the door.

The present invention in its second aspect provides a notification method executed in a delivery robot, the method comprising: acquiring external environment information; controlling traveling of the delivery robot to a delivery destination in a building on the basis of the acquired environment information; and performing notification in a case where an opening operation of a door existing in a traveling direction of the delivery robot is detected during the traveling of the delivery robot on the basis of the acquired environment information, wherein notification by at least one of light and sound is performed toward the door.

According to the present invention, it is possible to reduce the possibility of collision caused by the opening operation of the door.

### BRIEF DESCRIPTION OF THE DRAWINGS

FIG. 1 is a diagram illustrating a configuration in which an automatic delivery robot is used;

FIG. 2 is a diagram for explaining movement of the automatic delivery robot in a floor;

FIG. 3 is a block diagram illustrating a configuration of a control unit of the automatic delivery robot;

FIG. 4 is a diagram illustrating the configuration of a server;

FIG. 5 is a flowchart illustrating processing of a self-propelled operation of the automatic delivery robot;

FIG. 6 is a flowchart illustrating a delivery process of S110;

FIG. 7 is a flowchart illustrating a transfer process of S205;

FIG. 8 is a flowchart illustrating a door detection process;

FIG. 9 is a flowchart illustrating a notification start process;

FIG. 10 is a flowchart illustrating an emergency control process;

FIG. 11 is a view illustrating an aspect in which a light is projected on a door; and

FIG. 12 is a view illustrating the aspect in which the light is projected on the door.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

When a delivery robot is traveling in a corridor in a building, a door of a room facing the corridor may suddenly open. However, it is extremely difficult for the delivery robot to cope with the opened door itself, and it is desirable to prevent occurrence of such a situation in advance.

According to the following embodiment, it is possible to reduce a possibility of collision caused by the opening operation of the door.

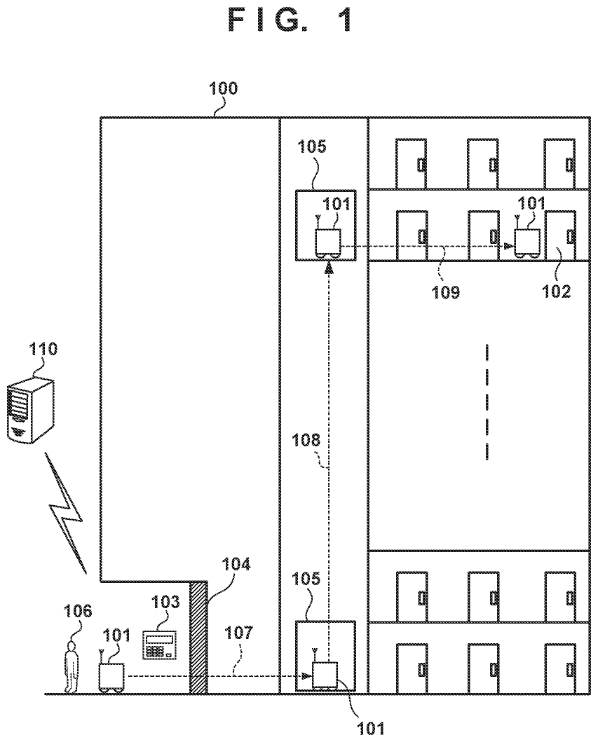

FIG. 1 is a diagram for explaining an operation of an automatic delivery robot according to the present embodiment. FIG. 1 illustrates an aspect in which an automatic delivery robot 101 gets on an elevator 105 in a building 100 and self-travels to a room 102 on a certain floor. The building 100 is, for example, a high-rise apartment provided with a plurality of floors, and the automatic delivery robot 101 is used, for example, to deliver a delivery item to a resident of the room 102.

A worker of a delivery company 106 drives a vehicle (for example, a delivery vehicle) (not illustrated) for the purpose of delivering the delivery item to the resident of the room 102. At that time, the automatic delivery robot 101 is stored in the vehicle. When the worker 106 stops the vehicle in front of an entrance 104 of the building 100 and places the automatic delivery robot 101 in front of the entrance 104, the worker 106 calls the room number of the room 102 by using an interphone 103. If the resident is confirmed to be at home, the worker 106 stores the delivery item in the storage section of the automatic delivery robot 101 and starts a self-propelled operation.

After the start of the self-propelled operation, the automatic delivery robot 101 moves to the front of the elevator 105 as indicated by an arrow 107 and waits for the elevator 105. When detecting that the door of the elevator 105 is opened, the automatic delivery robot 101 gets on the elevator 105 and designates the floor of the room 102 as a destination, thereby moving to the floor of the room 102 as indicated by an arrow 108. When detecting that the door of the elevator 105 is opened, the automatic delivery robot 101 gets off the elevator 105 and moves to the room 102 as indicated by an arrow 109. After the transfer of the delivery item to the resident of the room 102 is completed, the automatic delivery robot follows the reverse route of the arrows 107 to 109 to return to the position where the self-propelled operation was started. Incidentally, the building 100 is made such that the delivery service by the automatic delivery robot 101 can be received, and for example, operation of the elevator 105 and calling the room 102 are performed by near field wireless communication or the like.

The above assumption is an example, and other cases are also assumed. For example, the automatic delivery robot 101 may call the interphone 103 after the start of the self-propelled operation. In addition, in FIG. 1, only the movement to the room 102 has been described, but there is also a case where delivery items having a plurality of delivery destinations are stored in the storage section, and the automatic delivery robot 101 moves sequentially to a plurality of rooms. In this case, predetermined authentication information may be input instead of calling a room number with the interphone 103. In addition, when the delivery on a certain floor is completed, the automatic delivery robot 101 may move to another floor via the elevator 105 to perform delivery. In the present embodiment, it is assumed that after delivery to a plurality of delivery destinations on one floor, the automatic delivery robot 101 once returns to the position (in front of the entrance 104) where the self-propelled operation was started. In addition, in the above example, a case has been described in which the automatic delivery robot 101 is carried by the worker 106, but the automatic delivery robot 101 may be permanently placed in the building 100. In this case, only the worker 106 authenticated by the system of the building 100 can perform the delivery service using the automatic delivery robot 101.

The automatic delivery robot 101 can communicate with a server 110 installed outside the building 100. The server 110 is, for example, the system management server of the building 100 capable of cooperating with a server of a delivery company, and the automatic delivery robot 101 can acquire the floor map of the building 100, information regarding a delivery item, information regarding a delivery destination, and the like from the server 110. The information regarding a delivery item is, for example, the weight information of the delivery item. In addition, the information regarding a delivery destination is, for example, an at-home rate obtained on the basis of a past absence history or the like. The information regarding a delivery item and the information regarding a delivery destination may be collectively referred to as attribute information. Incidentally, the server 110 may be installed outside the building 100 or may be set inside the building 100. In addition, at least a part of the operation of the automatic delivery robot 101 may be implemented by control by the server 110. For example, the automatic delivery robot 101 may autonomously plan a travel route, or the server 110 may plan the travel route of the automatic delivery robot 101. In addition, the control of the automatic delivery robot 101 of the elevator 105 and the call bell of each room and the like may be implemented by communication via the server 110.

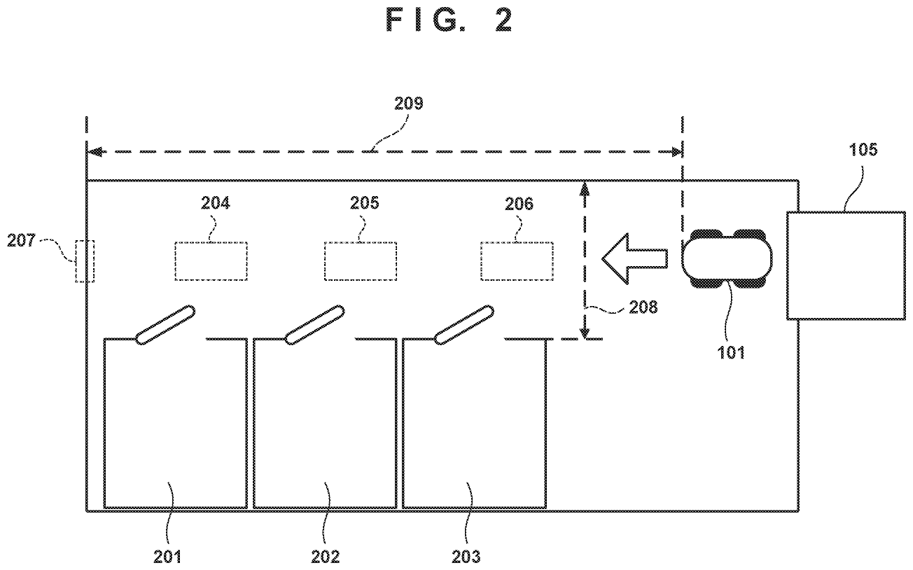

FIG. 2 is a diagram for explaining the movement of the automatic delivery robot 101 in the floor as indicated by the arrow 109 in FIG. 1. FIG. 2 illustrates an aspect at the time when the automatic delivery robot 101 gets off the elevator 105. FIG. 2 illustrates an aspect in which rooms 201, 202, and 203 exist on the floor, and doors can be opened and closed. The automatic delivery robot 101 moves in the direction of an arrow and can travel to a dead end 207 of a corridor (passage). A stop position is set in front of each room. A stop position 204 corresponds to the room 201, a stop position 205 corresponds to the room 202, and a stop position 206 corresponds to the room 203. After stopping at the stop position in front of the delivery destination room, the automatic delivery robot 101 rings the call bell of the room and transfers the delivery item to the resident.

A width 208 is the width of the corridor, and a length 209 is the length of the corridor from the movement start position, which is the starting point of movement in the floor where the automatic delivery robot 101 is positioned in FIG. 2, to the dead end 207. The automatic delivery robot 101 may determine the dead end 207 on the basis of a recognizable detection object. In addition, the automatic delivery robot 101 may acquire the length 209 from the measurement result of a distance measuring sensor, for example, and determine the dead end 207 on the basis of the acquired length 209. Each of the stop positions 204 to 206 is set at a predetermined position in front of each room, and is set, for example, at a position that allows the automatic delivery robot 101 to avoid the opening and closing operation of the door as much as possible while traveling and to perform transfer without the resident fully opening the door.

The automatic delivery robot 101 stops at the stop position corresponding to the delivery destination room while reciprocating from the movement start position to the dead end 207 and transfers the delivery item to the resident. For example, the automatic delivery robot 101 starts traveling from the movement start position, and stops at the stop position 206 in a case where the delivery destination is the room 203. Thereafter, traveling is started again, and in a case where the next delivery destination is the room 201, the automatic delivery robot passes through the stop position 205 and travels to the stop position 204. Then, when it reaches the dead end 207, the automatic delivery robot 101 travels in an opposite direction to return to the movement start position.

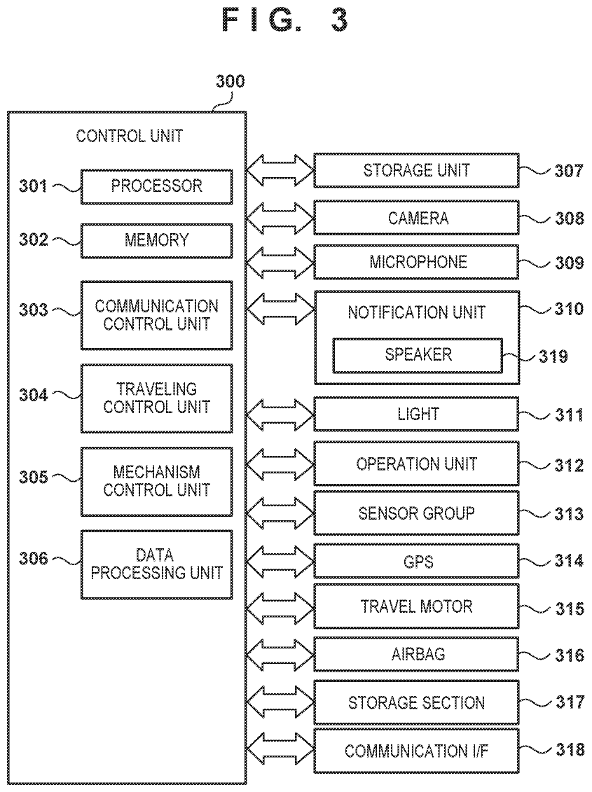

FIG. 3 is a block diagram illustrating an example of a configuration of a control unit of the automatic delivery robot 101. A control unit 300 is configured as, for example, an electronic control unit (ECU) and is mounted on the automatic delivery robot 101, and integrally controls the automatic delivery robot 101. The control unit 300 includes a processor 301 such as a central processing unit (CPU), a memory 302 such as a read-only memory (ROM), an electrically erasable programmable read-only memory (EEPROM), or a random-access memory (RAM), a communication control unit 303, a traveling control unit 304, a mechanism control unit 305, and a data processing unit 306. The operation of the automatic delivery robot 101 in the present embodiment is implemented by, for example, the processor 301 reading and executing a program stored in the memory 302. That is, the device including the control unit 300 can be a computer for realizing the invention.

The memory 302 stores a control program and data for controlling the operation of each unit of the automatic delivery robot 101. For example, the memory 302 stores a traveling control program and data for speed control and position control, and a communication control program and data for communication control with the outside. In addition, the memory 302 also stores a device control programs and data (a delivery destination, a route plan, and the like) for controlling devices such as a camera 308, a microphone 309, a notification unit 310, a light 311, and a storage section 317. The automatic delivery robot 101 can autonomously travel in the building 100 on the basis of external environment information and the route plan. In addition, the above-described program and data may be stored in a storage unit 307 such as a hard disk configured outside the control unit 300. The program, the memory 302, and the storage unit 307 can be a program and a computer-readable storage medium for realizing the invention.

The communication control unit 303 controls communication with the outside on the basis of the communication control program and data stored in the memory 302. The communication with the outside includes, for example, communication with equipments such as the elevator 105 or the call bell of each room in the building 100, communication with the server 110, and communication with a mobile terminal such as a smartphone held by the resident or the worker 106. The traveling control unit 304 controls traveling (including forward/reverse operation and turning operation) in the building 100 on the basis of the traveling control program and data stored in the memory 302 and the external environment information acquired by the camera 308, the microphone 309, and a sensor group 313. The mechanism control unit 305 controls each device on the basis of the device control program and data stored in the memory 302. For example, the mechanism control unit 305 controls directions, angles, and the like of the camera 308, the microphone 309, and the light 311. The data processing unit 306 includes, for example, a graphical processing unit (GPU), and processes data generated inside the automatic delivery robot 101 or received from the outside. The data to be processed by the data processing unit 306 includes, for example, data corresponding to an operation received from the worker 106 or the resident via an operation unit 312 and data received from the server 110.

The camera 308 is a camera that captures the vicinity of the automatic delivery robot 101. A plurality of cameras 308 may be provided, and can acquire, for example, a left front/rear captured image and a right front/rear captured image. In addition, the camera 308 includes a mechanism for adjusting an angle in a horizontal direction and a mechanism for adjusting an angle in a vertical direction. The microphone 309 is a directional microphone that inputs a sound around the automatic delivery robot 101. The microphone 309 includes a mechanism for adjusting an angle in the horizontal direction and a mechanism for adjusting an angle in the vertical direction. The data processing unit 306 analyzes data input via the camera 308 or the microphone 309. For example, the data processing unit 306 analyzes sound data input via the microphone 309, and recognizes an opening/closing sound or an unlocking/locking sound of the door, and a voice from the resident walking in the corridor of the building 100. In addition, for example, the data processing unit 306 analyzes imaging data (including still images/moving images) captured by the camera 308, and recognizes the door or an opening operation of the door.

The notification unit 310 includes, for example, a lamp, an indicator, and a speaker 319, and can notify the surroundings by sound or display. The operation unit 312 (control panel) includes a touch panel and displays a user interface screen such as a guidance screen, and can receive an operation of the resident of the delivery destination, for example.

The light 311 is a light for projecting light to a specific area in the traveling direction of the automatic delivery robot 101. A plurality of lights 311 may be provided, and can project light to a left front/rear side and a right front/rear side, for example. In addition, the light 311 includes a mechanism for adjusting an angle in the horizontal direction and a mechanism for adjusting an angle in the vertical direction. In the present embodiment, data corresponding to each of a plurality of colors and patterns is stored in the memory 302, and light having the color or the pattern determined by the control unit 300 from among the plurality of colors is projected toward a specific area in the traveling direction.

The sensor group 313 includes various sensors related to the operation of the automatic delivery robot 101, and includes, for example, an orientation sensor, a speed sensor, an acceleration sensor, an obstacle detection sensor, and a distance measuring sensor. A global positioning system (GPS) 314 receives a radio wave from a GPS satellite and acquires information indicating the current position (latitude, longitude) of the automatic delivery robot 101. A travel motor 315 drives a travel mechanism of the automatic delivery robot 101 such as wheels.

An airbag 316 is a cushioning member for absorbing impact when the automatic delivery robot 101 comes into contact with a resident walking in the corridor in the building 100, a wall or an equipment in the building 100, or the like, and is provided on at least one of four sides of the automatic delivery robot 101. The airbag 316 is activated under the control of the control unit 300, but may be a cushioning member having no control mechanism instead of the airbag 316.

The storage section 317 is a box capable of storing a delivery item, and locking/unlocking of the box is controlled by the mechanism control unit 305. Incidentally, the storage section 317 may be divided into a plurality of sections according to the delivery destination, and the locking/unlocking may be controlled for each section. A communication interface (I/F) 318 has a configuration corresponding to a communication medium such as an antenna, and enables communication with the outside. The communication I/F 318 can perform wireless communication such as Bluetooth or Wi-Fi (registered trademark). The communication control unit 303, the traveling control unit 304, the mechanism control unit 305, and the data processing unit 306 perform each control processing on the basis of communication with each of the blocks from the storage unit 307 to the communication I/F 318. Incidentally, the configuration of the automatic delivery robot 101 is not limited to the block configuration illustrated in FIG. 3, and may appropriately include another block in accordance with function that can be implemented by the automatic delivery robot 101.

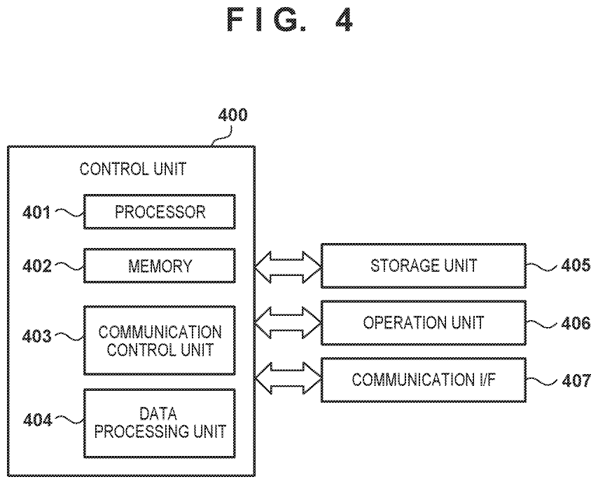

FIG. 4 is a diagram illustrating an example of a configuration of the server 110. The server 110 is configured as a general information processing apparatus such as a personal computer (PC). A control unit 400 is a control board for integrally controlling the server 110. The control unit 400 includes a processor 401 such as a CPU, a memory 402 such as a ROM, an EEPROM, or a RAM, a communication control unit 403, and a data processing unit 404. The memory 402 stores a control program and data for controlling the operation of each unit of the server 110. In addition, such programs and data may be stored in a storage unit 405 such as a hard disk configured outside the control unit 400. The operation of the server 110 in the present embodiment is implemented by, for example, the processor 401 reading and executing a program stored in the memory 402. That is, a device including the control unit 400 can be a computer in the invention. In addition, the program, the memory 402, and the storage unit 405 can be a program for realizing the invention and a computer-readable storage medium. The communication control unit 403 controls communication with the outside on the basis of a communication control program and data stored in the memory 402. For example, the communication control unit 403 of the server 110 controls, for example, communication with the automatic delivery robot 101 and communication with the mobile terminal such as a smartphone held by the resident or the worker 106. The data processing unit 404 processes data generated inside the server 110 or received from the outside.

The storage unit 405 stores programs and data used in the present embodiment. For example, the storage unit 405 stores the floor map of the building 100, authentication information determined for each worker 106, and identification information of the automatic delivery robot 101. In addition, a database based on big data may be configured in the storage unit 405. For example, the configuration may be made such that the delivery result (for example, transfer completion/absence, time information) transmitted from the automatic delivery robot 101 is stored as big data in the storage unit 405, and the data processing unit 404 including a GPU can analyze the tendency of the data. An operation unit 406 includes a hardware key and a panel, and can display various user interface screens to the user of the server 110 and accept user operations. A communication I/F 407 has a configuration corresponding to a communication medium and enables communication with the outside.

Incidentally, the configuration of the server 110 is not limited to the block configuration illustrated in FIG. 4, and can include other blocks as appropriate in accordance with functions that can be implemented by the server 110. In addition, the server 110 may be configured as a single device or may be configured by a plurality of devices. In addition, a part of the functions of the server 110 may be implemented by the automatic delivery robot 101, or a part of the functions (for example, route plan) of the automatic delivery robot 101 may be implemented by the server 110. For example, a part of the configuration of the control unit 300 in FIG. 3 may be mounted on the server 110.

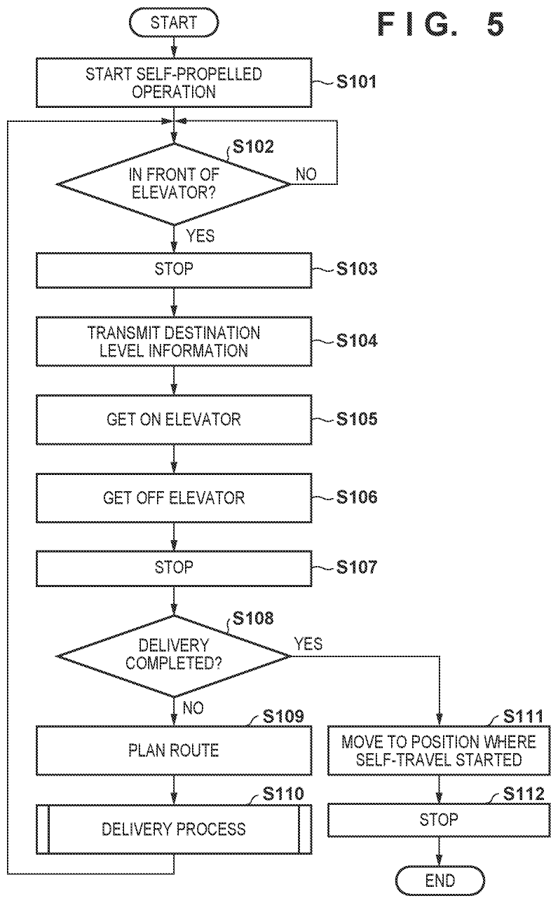

FIG. 5 is a flowchart illustrating processing of the self-propelled operation of the automatic delivery robot 101. The processing of FIG. 5 is implemented, for example, by the processor 301 reading and executing the program of the memory 302. In S101, the processor 301 starts the self-propelled operation. For example, the processor 301 starts the self-propelled operation by receiving an instruction from the worker 106 via the operation unit 312 or a hard switch. At that time, the processor 301 acquires delivery destination information. Here, it is assumed that the rooms 201, 202, and 203 in FIG. 2 are acquired as the delivery destinations. Hereinafter, the rooms 201, 202, and 203 may be referred to as delivery destinations 201, 202, and 203, respectively. The delivery destination information may be received from the worker 106 via the operation unit 312 or may be received from the server 110.

After the start of the self-propelled operation, the automatic delivery robot 101 moves toward the elevator 105 after passing through the entrance 104. For this operation, for example, a traffic line for the automatic delivery robot 101 may be provided, or the operation may be performed under the control of the server 110. Alternatively, the automatic delivery robot 101 may move autonomously by the image analysis of the imaging data of the camera 308. At the time of movement, the processor 301 repeatedly determines whether or not the automatic delivery robot 101 has moved to the front of the elevator 105. In a case where it is determined that the automatic delivery robot has moved to the front of the elevator 105, in S103, the processor 301 stops the automatic delivery robot 101.

In S104, the processor 301 transmits the information of a destination level (floor). Here, the destination level is the level of the floor where the delivery destination exists. The transmission destination of the information may be the elevator 105 or the server 110. When detecting a state where the door of the elevator 105 is opened, in S105, the processor 301 controls the automatic delivery robot 101 to travel to get on the elevator 105. When the elevator 105 arrives at the destination level, and the processor 301 detects a state where the door of the elevator 105 is opened, in S106, the automatic delivery robot 101 is controlled to travel to get off the elevator 105. In S107, the processor 301 stops the automatic delivery robot 101 at a position away from the elevator 105 by a predetermined distance.

In S108, the processor 301 determines whether or not the delivery to the delivery destination on the currently focused floor is completed. In a case where it is determined that the delivery is not completed, in S109, the processor 301 plans a route on the currently focused floor. Then, in S110, the processor 301 executes a delivery process. The delivery process will be described later.

After the delivery process is performed in S110, the processing from S102 is repeated. In this case, in S102, it is determined whether or not the automatic delivery robot has moved to the front of the elevator 105 on the currently focused floor. Then, in a case where it is determined that the automatic delivery robot has moved to the front of the elevator 105, in S103, the processor 301 stops the automatic delivery robot 101. The stopped position corresponds to the position where the automatic delivery robot has previously got off the elevator 105 in S106. In S104, the processor 301 transmits the information of the destination level. Here, the destination level is the level (for example, a first level) of the floor where the entrance 104 exists. In S105, the processor 301 controls the automatic delivery robot 101 to travel to get on the elevator 105. When the elevator 105 arrives at the destination level, and the processor 301 detects a state where the door of the elevator 105 is opened, in S106, the automatic delivery robot 101 is controlled to travel to get off the elevator 105. In S107, the processor 301 stops the automatic delivery robot 101 at a position away from the elevator 105 by a predetermined distance. In S108, the processor 301 determines whether or not the delivery to the delivery destination on the currently focused floor is completed. Here, it is determined that the delivery is completed, the processing proceeds to S111. In S111, the processor 301 controls the automatic delivery robot 101 to travel to move to the position where the self-propelled operation was started. When the position where the self-propelled operation was started is reached, the processor 301 stops the automatic delivery robot 101. Thereafter, the processing of FIG. 5 ends.

After the processing of FIG. 5 ends, in a case where the information of the delivery destination on another floor is acquired, the processing from S101 is repeated. In addition, in a case where the delivery to the delivery destinations of all floors of the building 100 is completed, the power may be turned off by the worker 106.

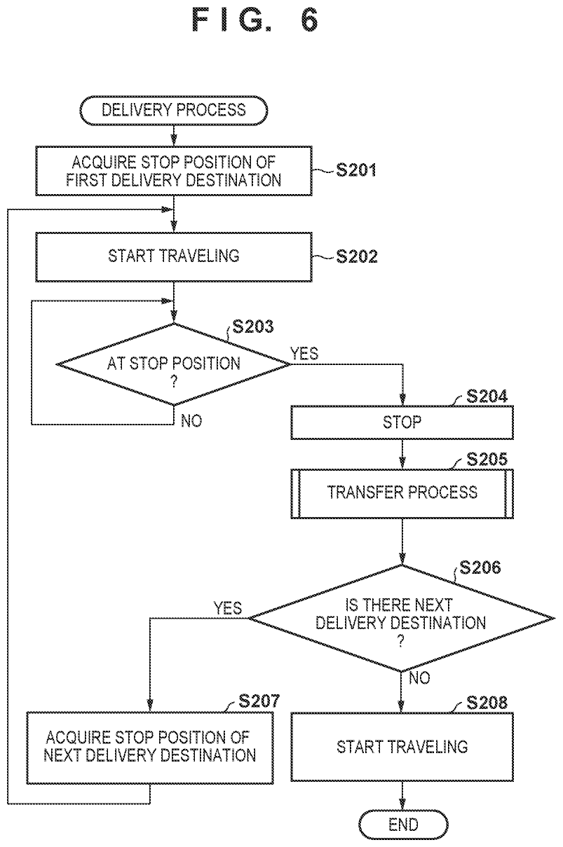

FIG. 6 is a flowchart illustrating the delivery process of S110. In S201, the processor 301 acquires the stop position of the first delivery destination (first delivery destination) on the basis of the planned route. The stop position of the first delivery destination is, for example, the stop position 205 corresponding to the delivery destination 202 in FIG. 2.

In S202, the processor 301 controls the automatic delivery robot 101 to travel to move to the stop position corresponding to the first delivery destination. In S203, the processor 301 determines whether or not the automatic delivery robot 101 reaches the stop position of the first delivery destination acquired in S201. In a case where it is determined that the automatic delivery robot 101 has not reached the stop position of the first delivery destination, the determination of S203 is repeatedly performed while continuing traveling. In a case where it is determined that the automatic delivery robot 101 has reached the stop position of the first delivery destination, the processor 301 stops the automatic delivery robot 101 in S204. Then, in S205, the processor 301 performs the transfer process of the delivery item to the resident. The transfer process will be described later.

After the transfer process is performed, in S206, the processor 301 determines whether or not there is a next delivery destination on the basis of the planned route. In a case where it is determined that there is no next delivery destination, the processing proceeds to S208. On the other hand, in a case where it is determined that there is the next delivery destination, in S207, the processor 301 acquires the stop position of the next delivery destination on the basis of the planned route. Then, the processing from S202 is repeated. In a case where it is determined that there is no next delivery destination in S206, the processor 301 controls the automatic delivery robot 101 to travel to return to the movement start position in S208. Thereafter, the processing of FIG. 6 ends.

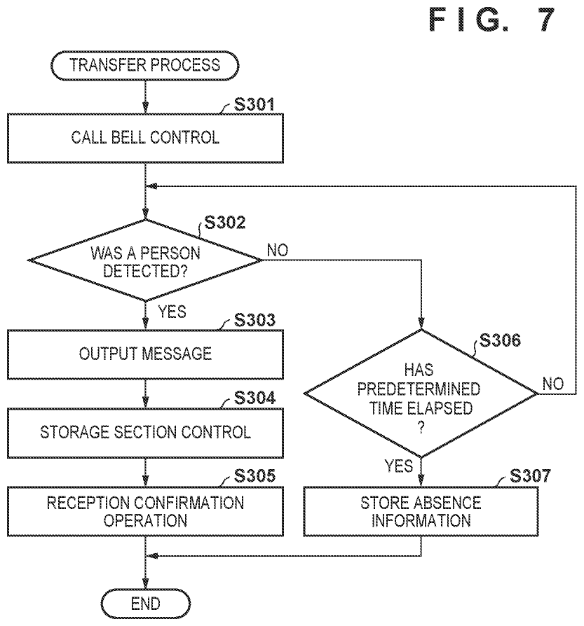

FIG. 7 is a flowchart illustrating the transfer process of S205. After stopping the automatic delivery robot 101 at the stop position corresponding to the delivery destination, in S301, the processor 301 performs control to ring the call bell of the delivery destination. For example, the processor 301 may transmit a ringing control signal to the call bell by near field wireless communication, or may transmit the ringing control signal to the server 110. In S302, the processor 301 determines whether or not the door is opened, and the resident is detected. The determination in S302 may be performed by the processor 301 by image analysis based on the imaging data captured by the camera 308, or may be performed using a human sensor, for example.

In a case where it is determined that no resident is detected in S302, in S306, the processor 301 determines whether or not a predetermined time has elapsed. In a case where it is determined that the predetermined time has not elapsed, the processing from S302 is repeated. In a case where it is determined that the predetermined time has elapsed, in S307, the processor 301 stores information indicating absence in a storage area such as the memory 302, and then ends the processing of FIG. 7. In a case where it is determined that the resident is detected in S302, the processing proceeds to S303.

In S303, the processor 301 outputs a message to the resident. For example, the processor 301 causes the panel of the operation unit 312 to display a guidance screen for prompting to take out the delivery item from the storage section. In S304, the processor 301 unlocks the storage section 317 so that the resident can take out the delivery item. Then, in S305, the processor 301 causes the panel of the operation unit 312 to display a screen for receiving a reception confirmation operation from the resident. When the reception confirmation operation is received from the resident, the processing of FIG. 7 ends.

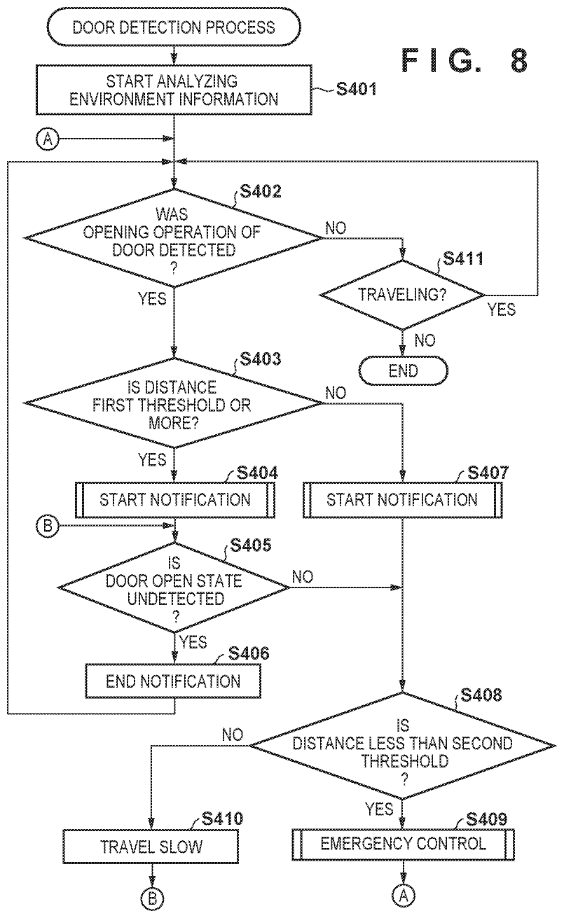

In the present embodiment, while the processing of FIG. 6 is being executed, the processing of FIG. 8 is executed in parallel. When the automatic delivery robot 101 is traveling in the building 100, the door of the room may suddenly open. However, it is extremely difficult for the automatic delivery robot 101 to cope with the opened door itself. In the present embodiment, when detecting that the door in the traveling direction opens or is about to open, the automatic delivery robot 101 projects light to a specific area in the traveling direction with the light 311. Here, the specific area is an area periphery of a gap at the bottom of the detected door. With such a configuration, it is possible to cause the resident who opens or is about to open the door to recognize the projected light and to sense that the automatic delivery robot 101 is approaching. As a result, it is possible to increase a possibility of avoiding the collision between the automatic delivery robot 101 and the door in advance by the resident closing the door again or stopping the opening operation.

FIG. 8 is a flowchart illustrating a door detection process. The processing of FIG. 8 is implemented, for example, by the processor 301 reading and executing the program of the memory 302. The processing of FIG. 8 is started, for example, when the traveling of the automatic delivery robot 101 is started in the processing of FIG. 6.

In S401, the processor 301 starts analyzing external environment information. Here, the environment information is, for example, the imaging data captured by the camera 308, the sound data acquired by the microphone 309, and the data acquired by the sensor group 313. Incidentally, the imaging data includes still image data and moving image data. As the analysis, for example, image analysis for the imaging data and sound analysis for the sound data are performed.

In S402, the processor 301 determines whether or not the opening operation of the door of the room in the traveling direction is detected as a result of the analysis of the environment information in S401. For example, in a case where the door opening operation is recognized on the basis of the frame image data at predetermined time intervals, it may be determined that the door opening operation is detected. In addition, for example, in a case where sound data of unlocking of a door, a thumb-turn, or a door knob is detected, the sound data may be recognized as a sign of opening of the door, and it may be determined that the opening operation of the door is detected. In addition, for example, in a case where there is a change in the measurement result by the distance measuring sensor or the like, that is, in a case where a reflected signal from the dead end 207 is detected in a state where the door of each room is closed, and a change occurs in the reflected signal due to the opening of the door of the room, it may be determined that the opening operation of the door is detected. In the determination process of S402, a plurality of types of environment information may be combined as well as one type of environment information is used. In the present embodiment, with such a configuration, it is possible to detect not only a state in which the door is completely opened but also an operation immediately before the door is opened. Thus, it is possible to further increase the possibility of avoiding the collision between the automatic delivery robot 101 and the door in advance.

In a case where it is determined that the door opening operation is detected in S402, the processing proceeds to S403. On the other hand, in a case where it is determined that the door opening operation is not detected in S402, the processing proceeds to S411. In S411, the processor 301 determines whether or not the automatic delivery robot 101 is traveling. Here, in a case where it is determined that the automatic delivery robot is traveling, the processing from S402 is repeated. On the other hand, in a case where it is determined that the automatic delivery robot is not traveling, for example, in a case where the delivery item is being transferred to the resident, the processing of FIG. 8 ends. After the end of FIG. 8, when the automatic delivery robot 101 starts traveling again, the processing of FIG. 8 is started.

In S403, the processor 301 estimates a distance to the door determined to detect the opening operation in S402, and determines whether or not the estimated distance is a first threshold or more. The estimation of the distance may be performed on the basis of, for example, the imaging data captured by the camera 308, the current position of the automatic delivery robot 101, and the floor map of the building 100. The first threshold is a predetermined distance such as an inter-door distance of five doors. In other words, in S403, it is determined whether or not the distance to the door of which the opening operation is detected is sufficiently far. In a case where it is determined that the estimated distance is the first threshold or more, in S404, the processor 301 starts notification for calling attention to the resident opening the door.

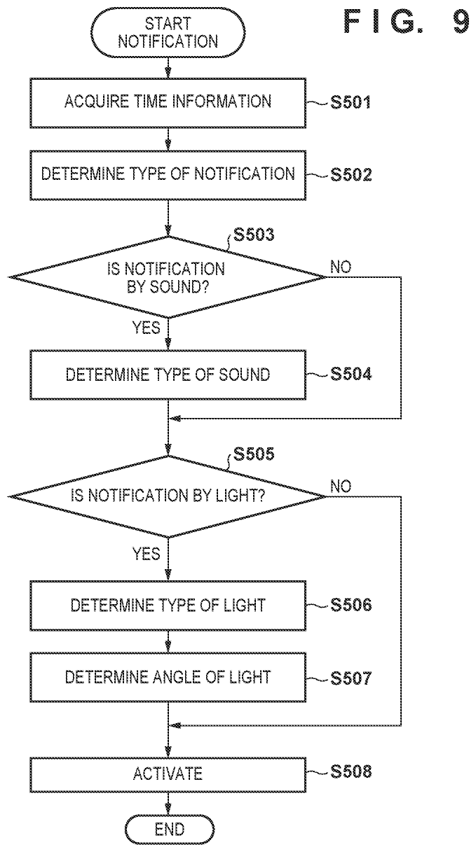

FIG. 9 is a flowchart illustrating a notification start process of S404. In S501, the processor 301 acquires current time information. Then, in S502, the processor 301 determines the type of notification. In the present embodiment, the type of notification includes at least one of the light projection by the light 311 and the sound notification by the speaker 319. The type of notification may be determined on the basis of the current time information acquired in S501. For example, in a case where the current time information indicates a predetermined time zone, for example, 8:00 to 17:00, it may be determined that the notification by light and sound projection is performed, and in a time zone other than the predetermined time zone, the notification by sound is not performed.

In S503, the processor 301 determines whether or not the notification by sound is determined in S502. When it is determined that the notification by sound is not determined, the processing proceeds to S505. On the other hand, in a case where it is determined that the notification by sound is determined, the processing proceeds to S504. In S504, the processor 301 determines the type of sound to be notified. For example, at the time when the processing of S404 is performed, the distance to the door of which the opening operation is detected is sufficient, and thus, not a sound of high urgency such as a siren sound but a sound with low urgency such as music is determined as the type of sound. In addition, the type of sound may be determined on the basis of the current time information acquired in S501. In addition, as the type of sound, a volume may be determined on the basis of the current time information. After S504, the processing proceeds to S505. In addition to the siren sound and music, a voice message such as “Delivery robot is coming.” may be used.

In S505, the processor 301 determines whether or not the notification by light is determined in S502. In a case where it is determined that the notification by light is not determined, the processing proceeds to S508. On the other hand, in a case where it is determined that the notification by light is determined, the processing proceeds to S506. In S506, the processor 301 determines the type of light to be notified. For example, the processor 301 determines, as the color of the projected light, a color different from the color of the environment such as the door or the floor of the corridor. For example, the processor 301 determines a color having a complementary color relationship with the color of the environment. In general, by arranging colors having a complementary color relationship, it is possible to make the user feel as if the saturation is stronger. In the present embodiment, for example, a color having a complementary color relationship with the color of the door or the floor is determined by using such an effect of complementary color comparison. In addition, in S506, the color of the light to be notified may be determined according to the illuminance of the illumination of the corridor. In addition, a light pattern may be determined as the type of light. For example, a blinking pattern may be determined. In S507, the processor 301 determines the angle of the light 311. In S507, the processor 301 determines the angle of the light 311 to project light to the periphery of the gap at the bottom of the door of which the opening operation is detected in S402.

After S507, in S508, the processor 301 activates at least one of the light 311 and the speaker 319 on the basis of each parameter for notification determined in at least one of S504, S506, and S507. Thereafter, the processing in FIG. 9 ends.

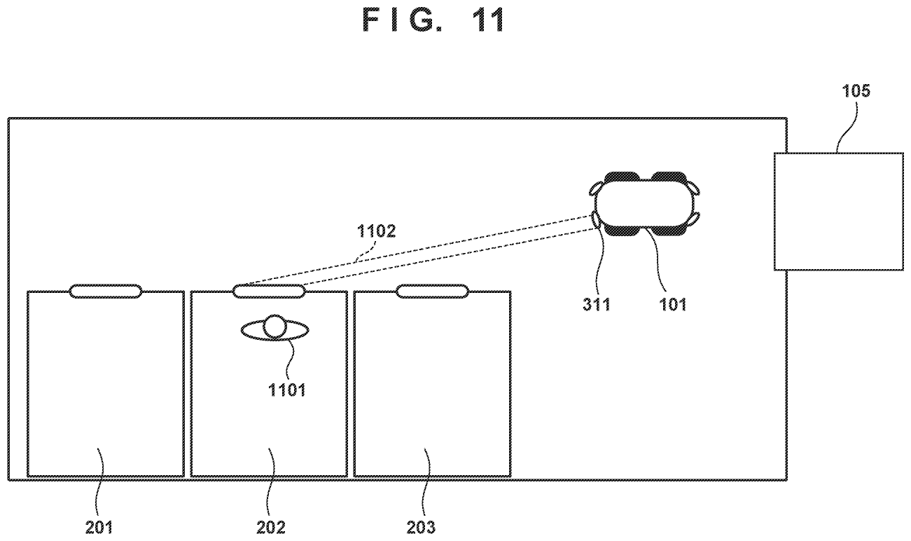

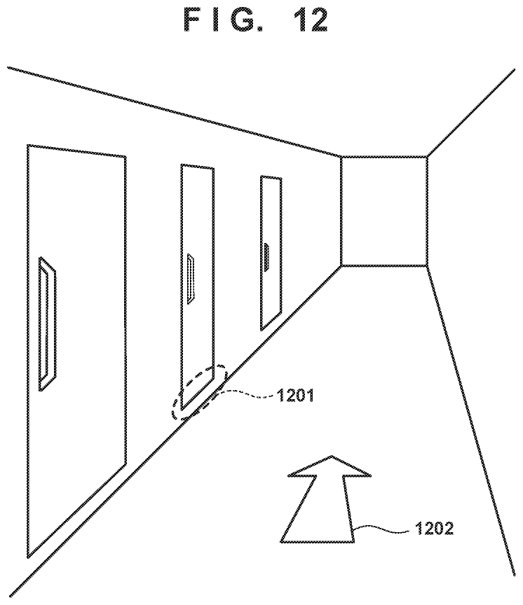

FIGS. 11 and 12 are diagrams illustrating an aspect in which light is projected on the door of the room 202 of which the opening operation is detected. FIG. 11 illustrates a case where the resident 1101 is about to turn the thumb-turn of the door, and illustrates that the door is about to be opened. The processor 301 detects the opening operation of the door of the room 202 by detecting the sound of the thumb-turn, and determines the angle of the light 311 to project light toward the door of the room 202. FIG. 11 illustrates an aspect in which light is projected toward the door of the room 202 from the light 311 on the left front in the traveling direction (a direction toward the left in the drawing) among the lights provided on four side surfaces of the automatic delivery robot 101. In addition, as illustrated in FIG. 12, light is projected toward an area 1201 periphery of the gap at the bottom of the door of which the opening operation is detected. Incidentally, an arrow 1202 in FIG. 12 indicates the traveling direction of the automatic delivery robot 101. As described above, according to the present embodiment, light is projected to the periphery of the gap at the bottom of the door, and thus it is possible to cause the resident who is about to open the door to recognize the approach of the automatic delivery robot 101.

FIG. 8 is referred to again. After S404, in S405, the processor 301 determines whether or not the door opening operation detected in S402 becomes undetected. For example, in a case where it is determined that the door opening operation becomes undetected, for example, in a case where the door is about to be opened but closed, in S406, the processor 301 ends the notification started in S404. Thereafter, the processing from S402 is repeated.

In a case where it is determined in S403 that the estimated distance to the door of which the opening operation is detected is not the first threshold or more, that is, less than the first threshold, in S407, the processor 301 starts notification for calling attention to the resident who opens the door similarly to S404.

In S408, the processor 301 determines whether or not the estimated distance to the door of which the opening operation is detected is less than a second threshold. Here, the second threshold is a distance shorter than the first threshold. In a case where it is determined that the estimated distance is less than the second threshold, the processor 301 performs an emergency control process in S409. In other words, a case where S409 is performed means that the estimated distance to the door of which the opening operation is detected is such a short distance that there is the possibility of collision with the door. In the present embodiment, in a case where it is determined that the estimated distance is less than the second threshold, the emergency control process is performed in consideration of the possibility of collision with the door.

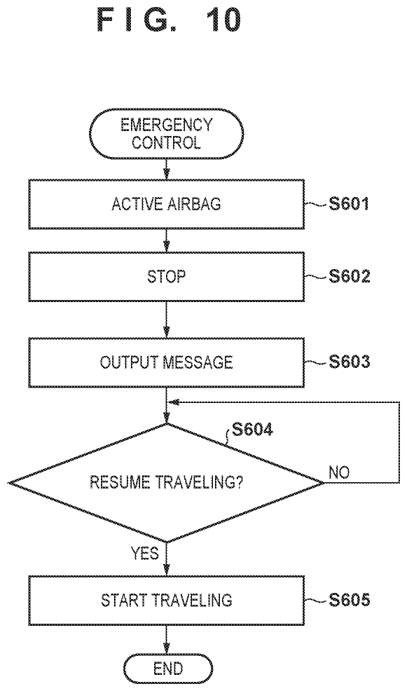

FIG. 10 is a flowchart illustrating the emergency control process of S409. In S601, the processor 301 activates the airbag 316. Then, in S602, the processor 301 stops the traveling of the automatic delivery robot 101, and in S603, outputs a message. The message may be, for example, a voice message such as “Emergency stop to avoid collision” from the speaker 319.

In S604, the processor 301 determines whether or not to resume the traveling. For example, in a case where the processor 301 recognizes that the door is closed on the basis of the external environment information, the processor determines to start the traveling. In a case where it is determined that the traveling is not resumed, the processing of S604 is repeated. In a case where it is determined to start the traveling, the processor 301 causes the automatic delivery robot 101 to start the traveling in S605. Thereafter, the processing of FIG. 10 ends, and the processing from S402 of FIG. 8 is repeated.

In a case where it is determined in S408 that the distance is not less than the second threshold, in S410, the processor 301 decreases the current traveling speed of the automatic delivery robot 101. Thereafter, the processing from S405 is repeated. After S408, in a case where it is determined in S405 that the opening operation of the door becomes undetected, in S406, the notification is ended, and the processor 301 performs control to return the traveling speed of the automatic delivery robot 101 to the speed before the decrease.

As described above, according to the present embodiment, in a case where the opening operation of the door is detected in the traveling direction while the automatic delivery robot 101 is traveling, notification is performed by light or sound. In particular, in the case of performing the notification by light, light is projected to the periphery of the gap at the bottom of the door. With such a configuration, the resident who opens the door is notified before the door is fully opened or before the door is opened, the possibility that the automatic delivery robot 101 collides with the door to be opened can be reduced. In addition, the notification process is performed during the traveling of the automatic delivery robot 101, and is not performed when the automatic delivery robot is stopped due to the transfer of the delivery item or the like. With such a configuration, power consumption can be suppressed, and a psychological burden on the resident due to light and sound can be reduced.

### Summary of Embodiment

The delivery robot of the above embodiment is a delivery robot that delivers a delivery item in a building, the delivery robot comprising: a first acquisition unit (308, 309, 313) configured to acquire external environment information; a travel control unit (300) configured to control traveling of the delivery robot to a delivery destination in the building on the basis of the environment information acquired by the first acquisition unit; and a notification unit (FIG. 8) configured to perform notification in a case where an opening operation of a door existing in a traveling direction of the delivery robot is detected during the traveling of the delivery robot on the basis of the environment information acquired by the first acquisition unit. The notification unit performs notification by at least one of light and sound toward the door.

With such a configuration, the resident who opens the door is notified before the door is fully opened or before the door is opened, the possibility that the automatic delivery robot 101 collides with the door to be opened can be reduced.

The first acquisition unit includes at least one of a camera (308) and a microphone (309), and the first acquisition unit acquires at least one of an image of an area including the door and a sound generated in the area as the environment information.

With such a configuration, for example, the opening operation of the door can be detected by an image or sound related to the opening operation of the door.

The delivery robot further comprises a second acquisition unit (S501) configured to acquire time information, wherein the notification unit performs the notification by at least one of the light and sound on the basis of the time information acquired by the second acquisition unit. The notification unit performs notification by sound in a case where the time information is included in a predetermined time zone.

With such a configuration, for example, it is possible to perform control such as not performing the notification by sound after the evening, and it is possible to perform notification in consideration of a living environment.

The delivery robot further comprises a first setting unit (S506) configured to set a type of light used in the notification unit, and the notification unit performs notification by the type of light set by the first setting unit. The first setting unit sets a color of light as the type of light. The color of light is a color different from a color of an environment in which the delivery robot travels.

With such a configuration, for example, it is possible to make it easier for the resident to recognize by notifying in a color different from the color of the door or the corridor.

The delivery robot further comprises a second setting unit (S504) configured to set a type of sound used in the notification unit, and the notification unit performs notification by the type of sound set by the second setting unit. The type of sound includes at least one of a siren sound and music.

With such a configuration, for example, the type of sound can be determined according to urgency.

When the notification unit performs notification by light, the light is projected toward a periphery of a gap at a bottom of the door.

With such a configuration, it is possible to notify a resident who is about to open the door before the door is fully opened.

When a distance to the door is shorter than a threshold, an airbag (316) is activated together with the notification by the notification unit.

With such a configuration, for example, in a case where the possibility of collision is high, a configuration for suppressing the impact of the collision can be activated.

The invention is not limited to the foregoing embodiments, and various variations/changes are possible within the spirit of the invention.

What is claimed is:

1. A delivery robot that delivers a delivery item in a building, the delivery robot comprising:
a first acquisition unit configured to acquire external environment information;
a travel control unit configured to control traveling of the delivery robot to a delivery destination in the building on the basis of the environment information acquired by the first acquisition unit; and
a notification unit configured to perform notification in a case where an opening operation of a door existing in a traveling direction of the delivery robot is detected during the traveling of the delivery robot on the basis of the environment information acquired by the first acquisition unit, wherein
the notification unit performs notification by at least one of light and sound toward the door.

2. The delivery robot according to claim 1, wherein
the first acquisition unit includes at least one of a camera and a microphone, and
the first acquisition unit acquires at least one of an image of an area including the door and a sound generated in the area as the environment information.

3. The delivery robot according to claim 1, further comprising:
a second acquisition unit configured to acquire time information, wherein
the notification unit performs the notification by at least one of the light and sound on the basis of the time information acquired by the second acquisition unit.

4. The delivery robot according to claim 3, wherein the notification unit performs notification by sound in a case where the time information is included in a predetermined time zone.

5. The delivery robot according to claim 1, further comprising:
a first setting unit configured to set a type of light used in the notification unit, wherein
the notification unit performs notification by the type of light set by the first setting unit.

6. The delivery robot according to claim 5, wherein the first setting unit sets a color of light as the type of light.

7. The delivery robot according to claim 6, wherein the color of light is a color different from a color of an environment in which the delivery robot travels.

8. The delivery robot according to claim 1, further comprising:
a second setting unit configured to set a type of sound used in the notification unit, wherein
the notification unit performs notification by the type of sound set by the second setting unit.

9. The delivery robot according to claim 8, wherein the type of sound includes at least one of a siren sound and music.

10. The delivery robot according to claim 1, wherein, when the notification unit performs notification by light, the light is projected toward a periphery of a gap at a bottom of the door.

11. The delivery robot according to claim 1, wherein, when a distance to the door is shorter than a threshold, an airbag is activated together with the notification by the notification unit.

12. A notification method executed in a delivery robot, the method comprising:
acquiring external environment information;
controlling traveling of the delivery robot to a delivery destination in a building on the basis of the acquired environment information; and
performing notification in a case where an opening operation of a door existing in a traveling direction of the delivery robot is detected during the traveling of the delivery robot on the basis of the acquired environment information, wherein
notification by at least one of light and sound is performed toward the door.
